(19) United States
(12) Patent Application Publication
(10) Pub. No.: US 2026/0309103 A1
(43) Pub. Date: Oct. 8, 2026

(54) NON-INTRUSIVE FUELING EVENT MEASUREMENT FOR FUELING SYSTEMS

(71) Applicant: Cummins-Scania HPCR System, LLC, Columbus, IN (US)

(72) Inventor: David Michael Carey, Bend, OR (US)

(21) Appl. No.: 19/481,754

(22) PCT Filed: May 14, 2024
(86) PCT No.: PCT/US2024/029230

§ 371 Date: Nov. 5, 2025

Related U.S. Application Data
(60) Provisional application No. 63/503,037, filed on May 18, 2023.

(51) Int. Cl. F02D 41/38; F02D 41/00; F02D 41/22; F02D 41/24; F02D 41/28

(52) U.S. Cl. CPC F02D 41/3845; F02D 41/0085; F02D 41/22; F02D 41/2467; F02D 41/28; F02D 2041/225; F02D 2041/288; F02D 2200/0602

(57) ABSTRACT

A system includes an engine comprising a plurality of combustion cylinders, a fueling system comprising a fuel rail in fluid communication with a plurality of fuel injectors, each of the plurality of fuel injectors being configured to provide fuel to a respective one of plurality of combustion cylinders, and a high-pressure fuel pump in fluid communication with the fuel rail, and an electronic control system in operative communication with the fueling system. The electronic is configured to receive pressure sensor output indicative of a fuel pressure of the fuel rail for a plurality of engine cycles, process the pressure sensor output to determine a fueling value indicative of a fuel quantity of an injection event of one of the plurality of fuel injectors, and in response to the fueling value, at least one of: adjust an injector control parameter to mitigate a difference between a commanded fueling quantity and an actual fueling quantity, display an operator perceptible output indicative of a condition of the system, and diagnose a condition of the system.

### CROSS-REFERENCE TO RELATED APPLICATIONS

The present disclosure claims priority to and the benefit of U.S. Application No. 63/503,037, filed May 18, 2023, and the same is hereby incorporated by reference.

### TECHNICAL FIELD

The present disclosure relates to non-intrusive fueling event measurement for fueling systems and related apparatuses, controls, diagnostic, processes, systems, and techniques.

### BACKGROUND

Fueling systems for internal combustion engines and controls for such systems suffer from a number of shortcomings including those respecting accuracy, complexity, computational burden, dedicated hardware requirements, precision, reliability, and robustness, among other shortcomings. There remains a significant need for the unique apparatuses, processes, systems, and techniques disclosed herein.

### DISCLOSURE OF EXAMPLE EMBODIMENTS

For the purposes of clearly, concisely, and exactly describing example embodiments of the present disclosure, the manner, and process of making and using the same, and to enable the practice, making and use of the same, reference will now be made to certain example embodiments, including those illustrated in the figures, and specific language will be used to describe the same. It shall nevertheless be understood that no limitation of the scope of the invention is thereby created, and that the invention includes and protects such alterations, modifications, and further applications of the example embodiments as would occur to one skilled in the art.

### SUMMARY

Certain embodiments comprise a unique apparatus for non-intrusive fueling event measurement for fueling systems. Certain embodiments comprise a unique processes for non-intrusive fueling event measurement for fueling systems. Certain embodiments comprise unique systems for non-intrusive fueling event measurement for fueling systems. Further embodiments, forms, objects, features, advantages, aspects, and benefits shall become apparent from the following description and drawings.

### BRIEF DESCRIPTION OF THE FIGURES

FIG. 1 is a schematic diagram illustrating certain aspects of an example system.

FIG. 2 is a schematic diagram illustrating certain aspects of the example system of FIG. 1.

FIG. 3 is a flow diagram illustrating certain aspects of an example process.

FIGS. 4A, 4B, 4C, and 4D are schematic diagrams illustrating certain aspects of example controls.

FIG. 5 is a schematic diagram illustrating certain aspects of example controls in combination with certain aspects of the example system of FIG. 1.

FIG. 6 is a graph depicting average total fueling of a plurality of injectors as a function of firing 3.0 order firing frequency pressure magnitude.

FIGS. 7-9 are graphs respectively depicting 0.5, 1.0, and 1.5 order fueling imbalance magnitude as function of 0.5, 1.0, and 1.5 order pressure magnitude.

FIGS. 10-12 are graphs respectively depicting 0.5, 1.0, and 1.5 order fueling imbalance phase as function of average total fueling.

### DETAILED DESCRIPTION OF EXAMPLE EMBODIMENTS

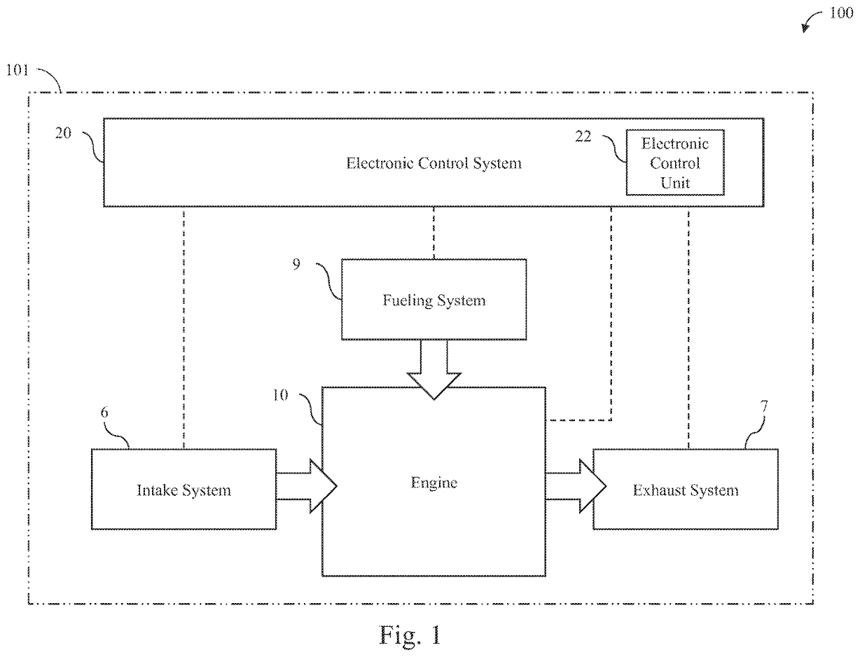

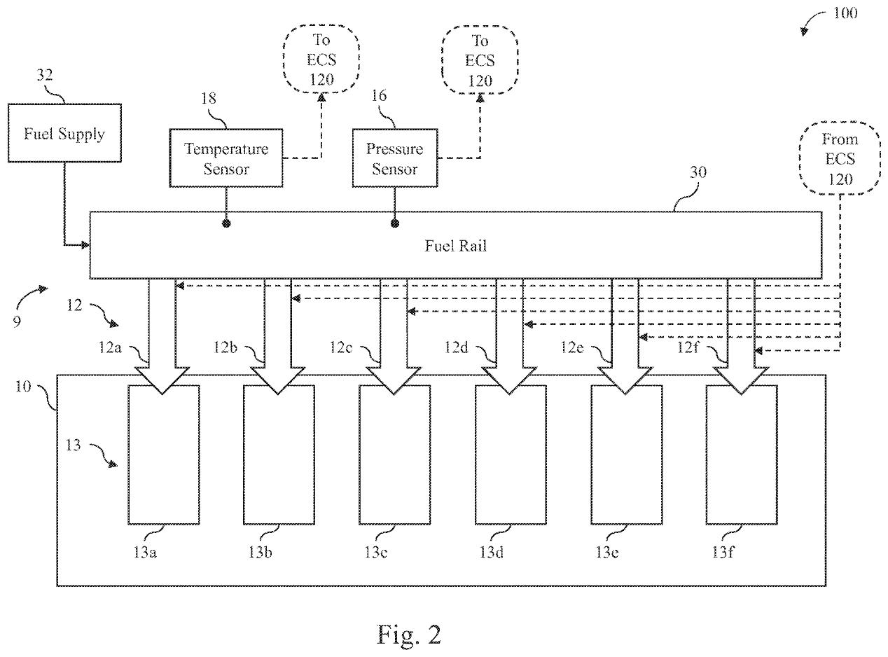

With reference to FIGS. 1 and 2, there is illustrated an example engine system 100 (also referred to as system 100) comprising an engine 10 operatively coupled with an intake system 7, an exhaust system 8, and a fueling system 9. The engine 10 may be an internal combustion engine, including but not limited to a compression-ignition engine, using diesel or other suitable fuel, or a spark-ignition engine, using gasoline, natural gas, or other suitable fuels. Engine 10 receives intake air from intake system 6 and fuel from fueling system 9, combusts these inputs and outputs exhaust via exhaust system 7

Engine 10 comprises a plurality of combustion cylinders 13 including respective reciprocating pistons (not depicted) configured to generate mechanical power from the combustion of a fuel. In the illustrated example, engine 10 is configured as a six-cylinder engine comprising combustion cylinders 13a, 13b, 13c, 13d, 13e, 13f. In other embodiments, engine 10 may be configured and provided with a different number of cylinders, for example, four cylinders, eight cylinders, twelve cylinders, sixteen cylinders, or other numbers of cylinders as will occur to one of skill in the art with the benefit and insight of the present disclosure.

Engine 10 comprises a plurality of fuel injectors 12 configured to provide fuel to respective combustion cylinders 13. In the illustrated example, engine 10 is comprises six injectors 12a, 12b, 12c, 12d, 12e, 12f in fluid communication and configured and operable to inject fuel into combustion cylinders 13a, 13b, 13c, 13d, 13e, 13f, respectively. It shall be appreciated that the number of fuel injectors provided in other embodiment may vary in correspondence to the number of cylinders, or may vary per-cylinder, for example, with multiple injectors being provided per-cylinder.

In the illustrated embodiment, fueling system 9 is configured and provided as a high-pressure common-rail fuel injection system including a fuel rail 14 configured and operable to supply fuel at a relatively high pressure to the plurality of fuel injectors 12. A fuel supply 32 is configured and operable to supply fuel to fuel rail 14 and may include a fuel reservoir 91, a low-pressure pump 92 operatively coupled with the fuel reservoir 91, and a high-pressure pump 93 operatively coupled with the low pressure pump 92 and the fuel rail 14. High-pressure fuel lines (not numbered) fluidically couple high pressure pump 93 with fuel rail 14, and fuel rail 14 with the plurality of injectors 12.

High pressure pump 92 is configured such that the frequency of individual pumping events does not coincide with the primary injection (firing) frequency or cylinder imbalance frequencies. More particularly, engine 10 has six cylinders 13a-13f, and high-pressure pump 93 is provided and configured as a 3-cylinder pump, with each pump cylinder producing two pumping events per pump shaft revolution, and a pump-to-engine speed ratio of 21:16, resulting in a pumping event-to-injection event ratio of 21:8. At 1500 RPM, this results in a firing frequency of 75 Hz and a pumping frequency of 196.875 Hz, with an individual pump cylinder frequency of 65.625 Hz. The engine cylinder imbalance frequencies are at 12.5, 25, and 37.5 Hz, which are below the individual pump cylinder frequency and primary pumping frequency. It shall be appreciated that this configuration is example of an engine system suitable for operation according to the apparatuses, controls, diagnostic, processes, systems, and techniques of the present disclosure.

System 100 further includes an electronic control system (ECS) 20 in communication with engine 10 and configured to control one or more aspects of engine 10, including controlling the injection of fuel into engine 10 via the fuel injectors 12. Accordingly, ECS 20 may be in communication with the fuel injectors 12 and configured to command each fuel injector 12 on and off at prescribed times to inject fuel into the engine 10 as desired. ECS 20 include at least one electronic control unit (ECU) 22 configured to execute operations of ECS 20 as described further herein and, in some embodiment, may include additional ECUs configured to execute operations of ECS 20 as described further herein.

ECS 20 may be further structured to control other parameters of engine 10, which may include aspects of engine 10 that may be controlled with an actuator activated by ECS 20. For example, ECS 20 may be in communication with actuators and sensors for receiving and processing sensor input and transmitting actuator output signals. Actuators may include, but not be limited to, fuel injectors 12. The sensors may include any suitable devices to monitor operating parameters and functions of the system 100. For example, the sensors may include a pressure sensor 16 and a temperature sensor 18. The pressure sensor 16 is in communication with the common fuel rail 14 and structured to communicate a measurement of the pressure within the common fuel rail 14 to the ECS 20. The temperature sensor 18 is in communication with the common fuel rail 14 and structured to communicate a measurement of the temperature within the common fuel rail 14 to the ECS 20. In at least one embodiment, system 100 may include an oxygen sensor 38 (e.g., a lambda sensor) in communication with the ECS 20 and structured to determine characteristics of exhaust gases generated and expelled by the engine 10. In one example, oxygen sensor 38 may determine the concentration of oxygen in the exhaust gases as a proxy for the concentration of regulated emissions.

As will be appreciated by the description that follows, the techniques described herein relating to fuel injector or fuel injection parameters can be implemented in ECS 20, which may include one or more controllers for controlling different aspects of the system 100. In one form the ECS 20 comprises one or more electronic control units (ECU) such as an engine control unit or engine control module. The ECS 20 may be comprised of digital circuitry, analog circuitry, or a hybrid combination of both of these types. Also, the ECS 20 may be programmable, an integrated state machine, or a hybrid combination thereof. The ECS 20 may include one or more Arithmetic Logic Units (ALUs), Central Processing Units (CPUs), memories, limiters, conditioners, filters, format converters, or the like which are not shown to preserve clarity. In one form, the ECS 20 is of a programmable variety that executes algorithms and processes data in accordance with operating logic that is defined by programming instructions (such as software or firmware). Alternatively or additionally, operating logic for the ECS 20 may be at least partially defined by hardwired logic or other hardware.

In addition to the types of sensors described herein, any other suitable sensors and their associated parameters may be encompassed by the system and methods. Accordingly, the sensors may include any suitable device used to sense any relevant physical parameters including electrical, mechanical, and chemical parameters of the engine system 100. As used herein, the term sensors may include any suitable hardware and/or software used to sense or estimate any engine system parameter and/or various combinations of such parameters either directly or indirectly.

Engine system 100 may be provided and implemented in connection with equipment 101 which may comprise, for example, a vehicle, such as an on-highway vehicle, an off-highway vehicle, a marine vehicle, or other type of vehicle, a generator set, a pumping set, or various other equipment as will occur to one of skill in the art with the benefit and insight of the present disclosure.

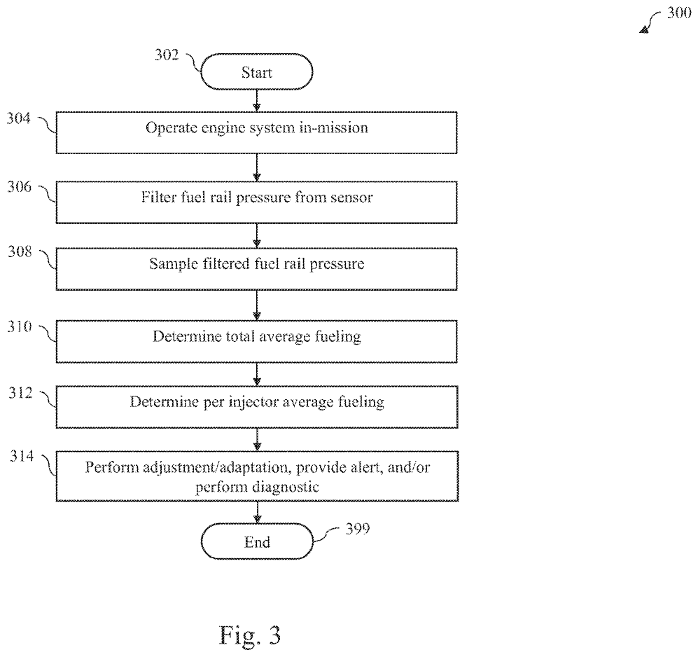

With reference to FIG. 3, there is illustrated a flow diagram illustrating certain aspects of an example process 300 which may be implement in and executed by one more components of an electronic control system, such as ECS 20, for example, in one or more electronic control units, such as ECU 22.

Process 300 begins as start operation 302 and proceeds to operation 304 at which an engine system such as engine system 100 or another suitable engine system. In the illustrated example, the engine system is operated in-mission meaning that it operates according to the needs of a particular mission or application without requiring entry into a test mode, test cell, or otherwise disrupting normal mission operation. It shall be appreciated that other embodiments may additionally or alternatively operate an engine system ex-mission, such as in a test mode, test cell, or other out of mission operation.

From operation 304, process 300 proceeds to operation 306 which filters output of a pressure sensor indicative of fuel rail pressure. Operation 306 may, for example, utilize the filtering techniques disclosed in connection with controls 400.

From operation 306, process 300 proceeds to operation 308 which samples a filtered fuel rail pressure provided by operation 306. Operation 306 may, for example, utilize the sampling techniques disclosed in connection with controls 400.

From operation 308, process 300 proceeds to operation 310 which determines a total average fueling in response to the sampled filtered fuel rail pressure provided by operation 308. Operation 310 may, for example, utilize techniques such as those disclosed in connection with controls 400.

From operation 310, process 300 proceeds to operation 312 which determines a per injector average fueling in response to the output provided by operation 310. Operation 312 may, for example, utilize techniques such as those disclosed in connection with controls 400.

From operation 312, process 300 proceeds to operation 314 which one or more of performs adjustment/adaptation of a system control parameter (e.g., closed loop adaptation of per injector controls), provides and alert, and/or performs a diagnostic in response to the output of operation 310. Operation 314 may, for example, utilize techniques such as those disclosed in connection with controls 400. From operation 314, process 300 proceeds to operation 399 and may end or repeat.

While process 300 is described in the context of fuel injection events by fuel injectors, it shall be appreciated that process 300 may analogously be applied, mutatis mutandis, in the context of pumping events by a high pressure fuel pump. In such applications, aspects of process 300 described above in relation to an injector or an injection generally correspond to a pump and a pumping event respectively.

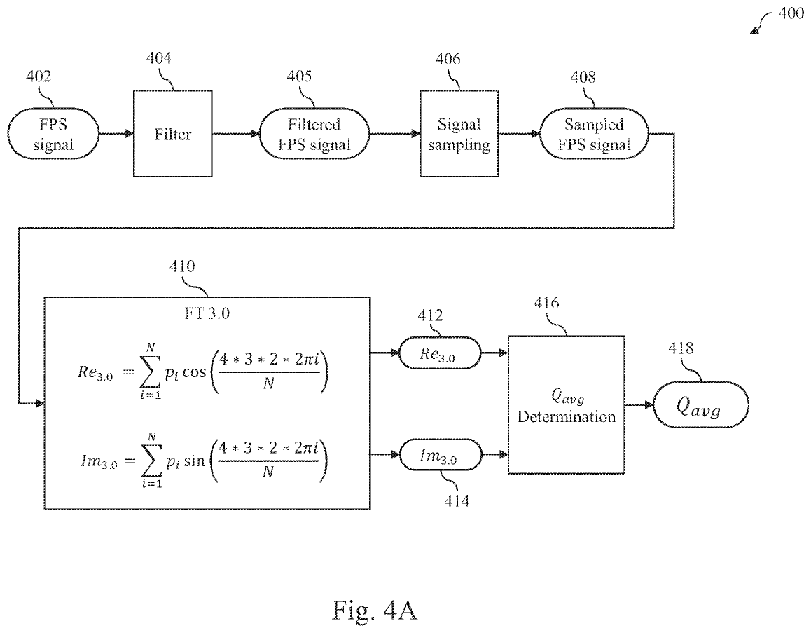

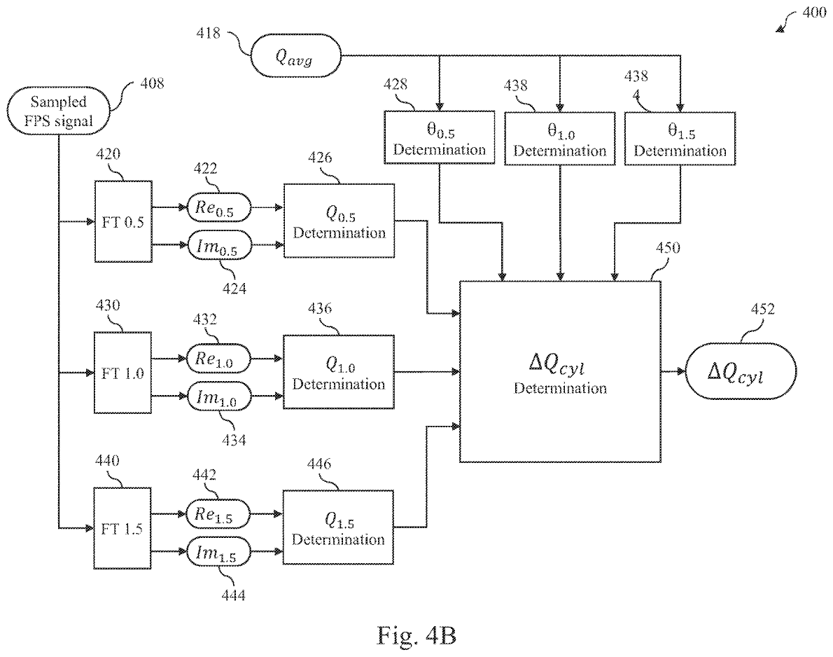

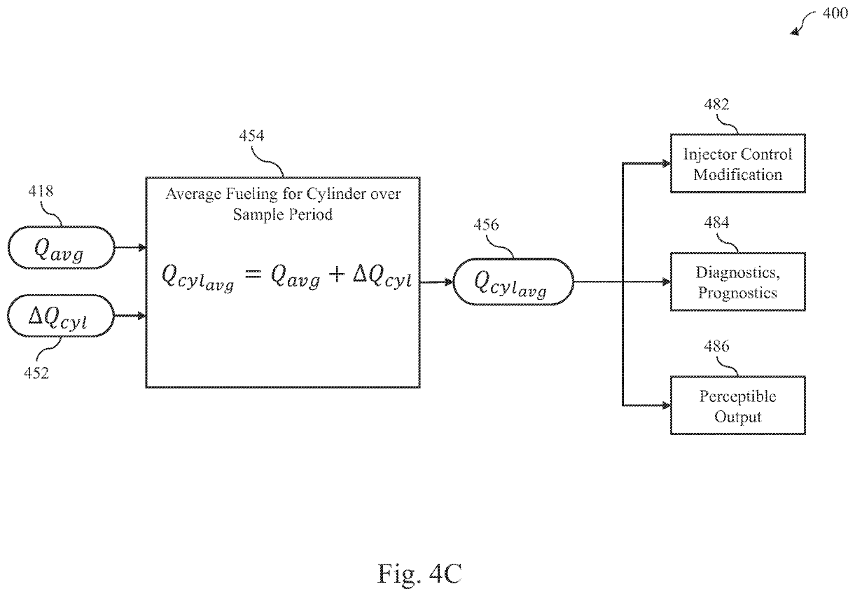

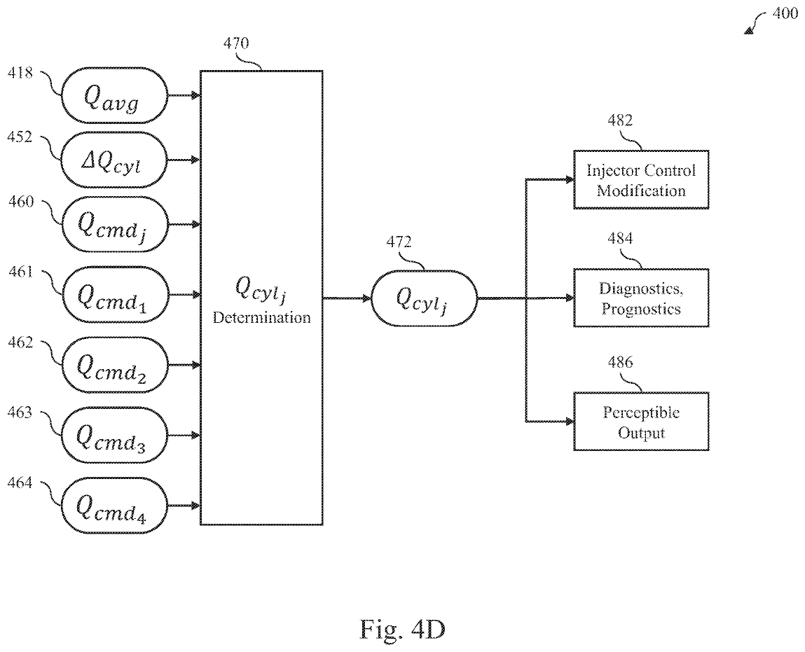

With reference to FIGS. 4A-4D, there are illustrated example controls 400 may be implement in and executed by one more components of an electronic control system, such as ECS 20, for example, in one or more electronic control units, such as ECU 22. Controls 400 include a filter 404 which receives as input a fuel pressure sensor (FPS) signal 402, for example, from a pressure sensor operatively coupled with and configured to sense fuel pressure of a fuel rail, such as pressure sensor 16 of system 100. Filter 404 may be configured to perform a number of filtering operations including, for example, applying a low-pass filter or performing low-pass filtering operations to provide anti-aliasing of FPS signal 402, applying a high-pass filter or performing high-pass filtering operations to provide mitigation or rejection of harmonics and/or noise, combinations of both of the aforementioned examples, and/or combinations of the foregoing with other filtering techniques.

Referring now to FIG. 4A, filter 404 provide a filtered FPS signal 405 to signal sampling operator 406 which is configured and operable to sample FPS signal 405. Operator 406 may be configure and operable to transform fuel pressure information from a continuous domain to a discrete domain. Signal sampling operator 406 may be configured and operable to sample filtered FPS signal at uniform crank angle intervals over a fixed, integer number of engine cycles. Signal sampling operator 406 provides sampled FPS signal 408 as output which is received by Fourier transform (FT) operator 410. It shall be appreciated that the operations of filter 404 and signal sampling operator 406 may be combined or interleaved in some embodiments.

FT operator 410 is configured and operable to determine a total fueling delivered (including injected fuel plus drain quantity fuel removed from a pressurized volume) by each injector can be determined by analyzing a partial Fourier transform of FPS signal 408. It shall be appreciated that partial Fourier transforms of FPS signal 408 may be described in terms of “engine order” which is analogous to frequency, but has units of events per revolution, rather than events per second. In the illustrated example FPS signal 408 has been sampled at uniform crank angle intervals over a fixed, integer number of engine cycles. Furthermore, as engine 10 is configured and provided as a six-cylinder engine, only four points of the Fourier transform are ultimately needed to determine injector fueling, namely, the firing frequency (3.0 engine order which corresponds to the fueling event frequency), and the three “cylinder imbalance” frequencies (0.5, 1.0, and 1.5 times the engine order). FT operator 410 is configured and operable to determine a partial Fourier transform of the firing frequency (3.0 engine order) comprising a real part (Re_{3.0}) and an imaginary part (Im_{3.0}) in accordance with equation (1) and equation (2) respectively:

$${Re}_{3.} = {\sum }_{i = 1}^{N} {p}_{i} cos ( \frac{4 * 3 * 2 * 2 π i}{N} ) \qquad ( 1 )$$

$${Im}_{3.} = {\sum }_{i = 1}^{N} {p}_{i} sin ( \frac{4 * 3 * 2 * 2 π i}{N} ) \qquad ( 2 )$$

In equation (1) and equation (2) pᵢ is a rail pressure sample I, N is a number of rail pressure samples in integer number of engine cycles (4 in this example), the factor “3” represents 3.0 engine order (i.e., 3 events per engine revolution), the factor of “2” represents 2 engine revolutions per engine cycle. It shall be appreciated that the Fourier transform determinations of equation (1) and equation (2) would also correspond to one bank of a V-12 engine, and that the constants firing frequency parameters may be adjusted in other embodiments to correspond to other engine configurations.

FT operator 410 determines and outputs a real part (Re_{3.0}) as output 412 and imaginary part (Im_{3.0}) as output 414. Output 412 and output 414 are provided as input to average fueling determination operator 416 which is configured and operable to determine and output average fueling parameter (Q_{avg}) 418. Average fueling determination operator 416 may be configured to determine a firing frequency pressure magnitude (Mg_{3.0}) in accordance with equation (3) as the square root of the sum of the squares of the a real part (Re_{3.0}) and the imaginary part (Im_{3.0}):

$${Mg}_{3.} = \sqrt{{Re}_{3.}^{2} + {Im}_{3.}^{2}} \qquad ( 3 )$$

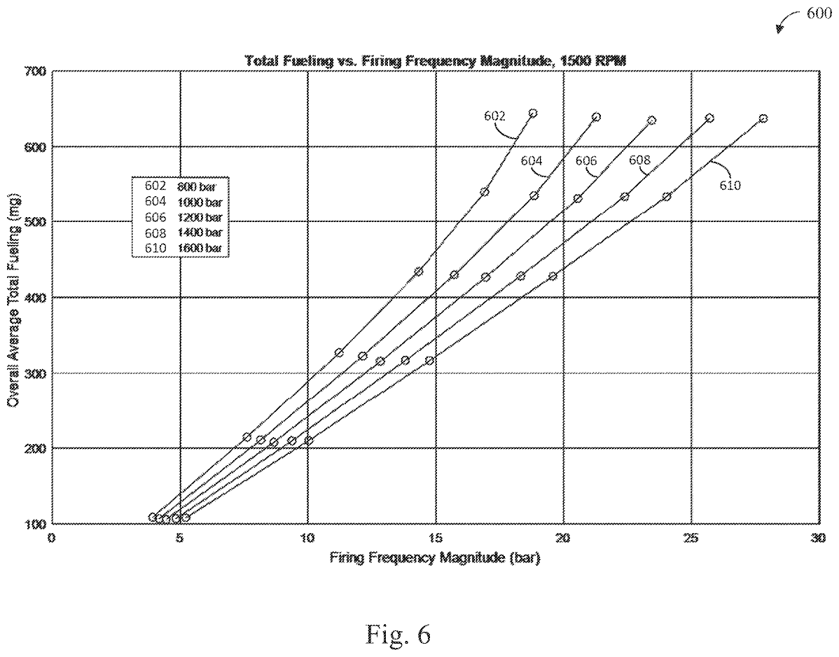

Average fueling determination operator 416 may be further configured to determine average fueling parameter 418 as a function of the firing frequency magnitude (Mg_{3.0}). In some embodiment, an overall average total fueling (Q_{avg}), can be determined using a look-up table specifying values of Q_{avg} as a function of rail pressure firing frequency magnitude and average pressure (or square of sonic speed). FIG. 6 illustrates a graph 600 depicting curves 602, 604, 606, 608, 610 of Q_{avg} as a function of firing frequency magnitude for a plurality of rail pressures. The relationships illustrated in graph 600 may be implemented in and specified by one or more lookup tables. In other embodiments, the overall average total fueling (Q_{avg}), can be determined by performing calculations using as set of linear or polynomial-fit equations generally corresponding to the relationships illustrated in FIG. 6 or generally corresponding to other empirically derived relationships.

It shall be appreciated that the determinations performed by operator 614 may reflect a relationship of overall average total fueling for all cylinders (over the rail pressure sample period) which is proportional to the magnitude of the rail pressure firing frequency, pressure level (or, more accurately, the square of sonic speed of the pressurized fuel), and inversely proportional to engine speed. In some embodiment, for example, a genset operating at constant speed (either 1500 or 1800 RPM), the speed dependency can be handled by having two sets of calibrations, one for 1500 RPM and another one for 1800 RPM. (Typical speed variation of a genset (+/−3 RPM) has an insignificant effect on the rail pressure signal.) The level of fueling imbalance between cylinders is also proportional to the magnitude of rail pressure imbalance frequencies and pressure level (or square of sonic speed).

Referring now to FIG. 4B, sampled FPS signal 408 is provided to FT operator 420, FT operator 430, and FT operator 440. FT operator 420 is configured and operable to determine a partial Fourier transform at 0.5 engine order comprising a real part (Re_{0.5}) which is provided as output 422 and an imaginary part (Im_{0.5}) which is provided as output 424. Output 422 and output 424 are provided as inputs to operator 426.

FT operator 430 is configured and operable to determine a partial Fourier transform at 1.0 engine order comprising a real part (Re_{1.0}) which is provided as output 432 and an imaginary part (Im_{1.0}) which is provided as output 434. Output 432 and output 434 are provided as inputs to operator 436.

FT operator 440 is configured and operable to determine a partial Fourier transform at 1.5 engine order comprising a real part (Re_{1.5}) which is provided as output 442 and an imaginary part (Im_{1.5}) which is provided as output 444. Output 442 and output 444 are provided as inputs to operator 446.

FT operator 420, FT operator 430, and FT operator 440 may determine their respective parameters in accordance with equation (4) and equation (5) respectively:

$${Re}_{f} = {\sum }_{i = 1}^{N} {p}_{i} cos ( \frac{4 * f * 2 * 2 π i}{N} ) \qquad ( 4 )$$

$${Im}_{f} = {\sum }_{i = 1}^{N} {p}_{i} sin ( \frac{4 * f * 2 * 2 π i}{N} ) \qquad ( 5 )$$

In equation (4) and equation (5) pᵢ is a rail pressure sample I, N is a number of rail pressure samples in integer number of engine cycles (4 in this example), the factor “f” is set to and represents engine order which is set to 0.5 for FT operator 420, 1.0 for FT operator 430, and 1.5 for FT operator 440. The factor of “2” represents 2 engine revolutions per engine cycle. It shall be appreciated that the Fourier transform determinations of equation (1) and equation (2) would also correspond to one bank of a V-12 engine, and that the engine order parameters may be adjusted in other embodiments to correspond to other engine configurations.

Operator 426, operator 436, and operator 446 are configured and operable to determine and fueling imbalance parameters (Q_{0.5}). Fueling parameter determination operator 426 may be configured to determine a frequency pressure magnitude (Mg_{f}) in accordance with equation (3) as the square root of the sum of the squares of the a real part (Res) and the imaginary part (Im_{f}) where f=0.5, 1.0, or 1.5 for operator 426, operator 436, and operator 446, respectively:

$${Mg}_{f} = \sqrt{{Re}_{f}^{2} + {Im}_{f}^{2}} \qquad ( 6 )$$

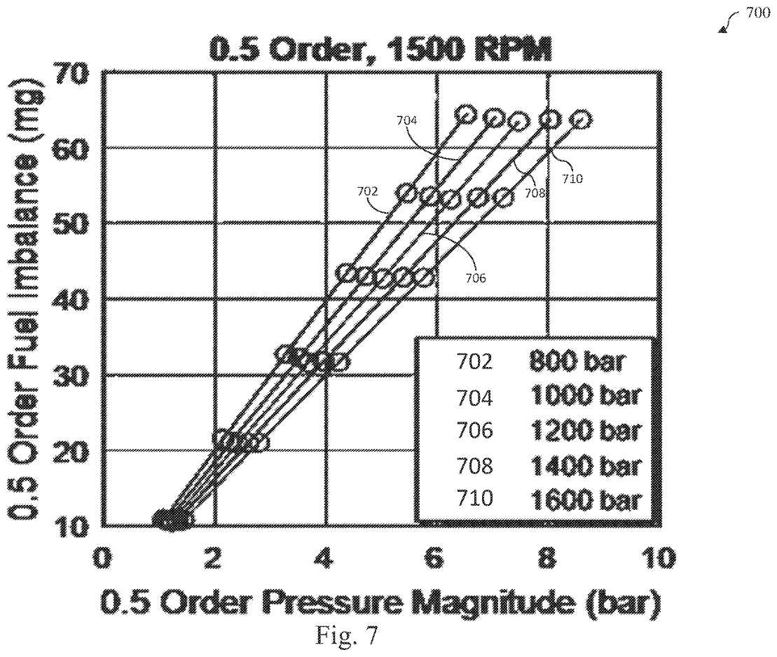

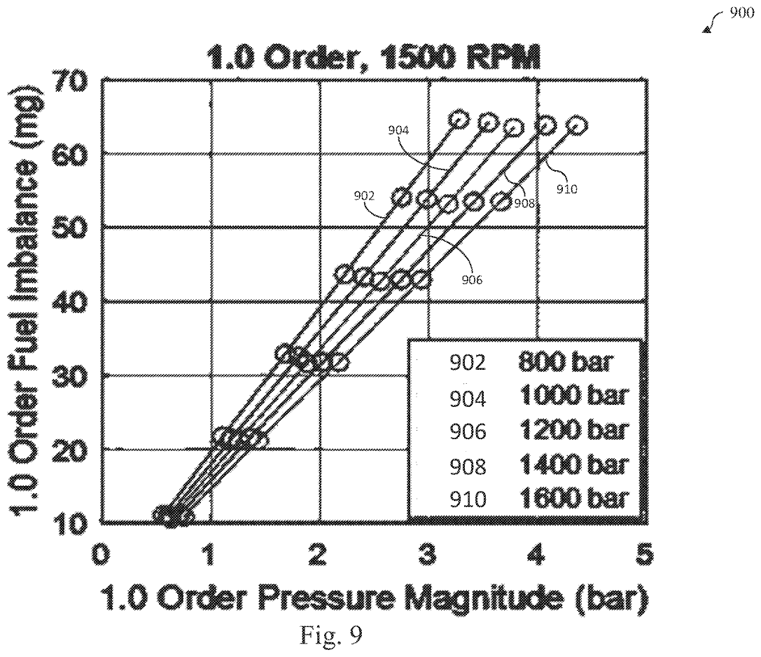

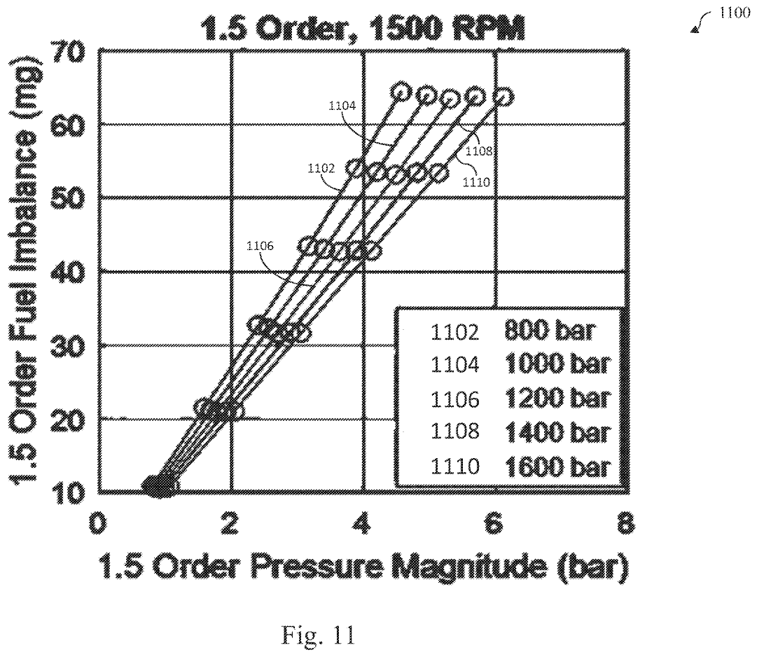

Operator 426, operator 436, and operator 446 may be further configured to determine a 0.5 order fueling imbalance parameter (Q_{0.5}), a 1.0 order fueling imbalance parameter (Q_{1.0} and a 1.5 order fueling imbalance parameter (Q_{1.5}), respectively, as a function of their respective frequency pressure magnitudes (Mg_{f}, where f=0.5, 1.0, 1.5). In some embodiment, the respective fueling imbalance parameters can be determined using look-up tables specifying values of Q_{0.5}, Q_{1.0}, and Q_{1.5} as a function of rail pressure firing frequency magnitude and average pressure (or square of sonic speed). FIG. 7 illustrates a graph 700 depicting curves 702, 704, 706, 708, 710 of Q_{0.5} as a function of 0.5 order pressure frequency magnitude for a plurality of rail pressures. FIG. 9 illustrates a graph 900 depicting curves 902, 904, 906, 908, 910 of Q_{1.0} as a function of 1.0 order pressure frequency magnitude for a plurality of rail pressures. FIG. 11 illustrates a graph 1100 depicting curves 1102, 1104, 1106, 1108, 1110 of Q_{1.5} as a function of 1.5 order pressure frequency magnitude for a plurality of rail pressures.

The relationships illustrated in graphs 700, 900, and 1100 may be implemented in and specified by one or more lookup tables. In other embodiments, the fueling imbalance parameters, can be determined by performing calculations using as set of linear or polynomial-fit equations generally corresponding to the relationships illustrated in FIG. 7, 9, or 11 generally corresponding to other empirically derived relationships.

It shall be appreciated that at a given engine speed, the magnitude of fueling imbalance at a given frequency is linearly proportional to the magnitude of the Fourier transform at that frequency. Furthermore, the phase reference of that fueling imbalance frequency is nearly linearly related to the overall total fueling level. “Phase reference” can be thought of as the phase of the imbalance frequency with respect to the top dead center position of cylinder #1 when cylinder #1 or a group of cylinders characteristic of the imbalance frequency is fueling more than the other cylinders or group of cylinders.

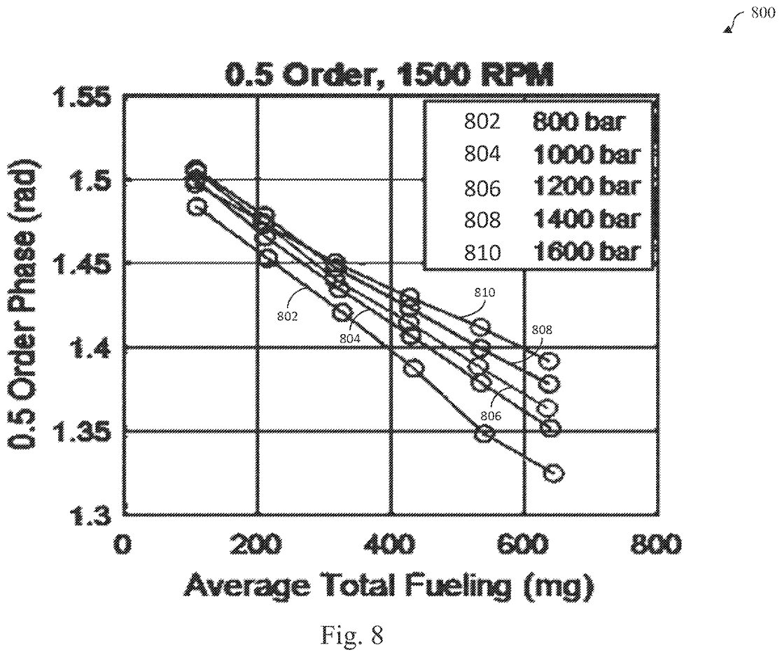

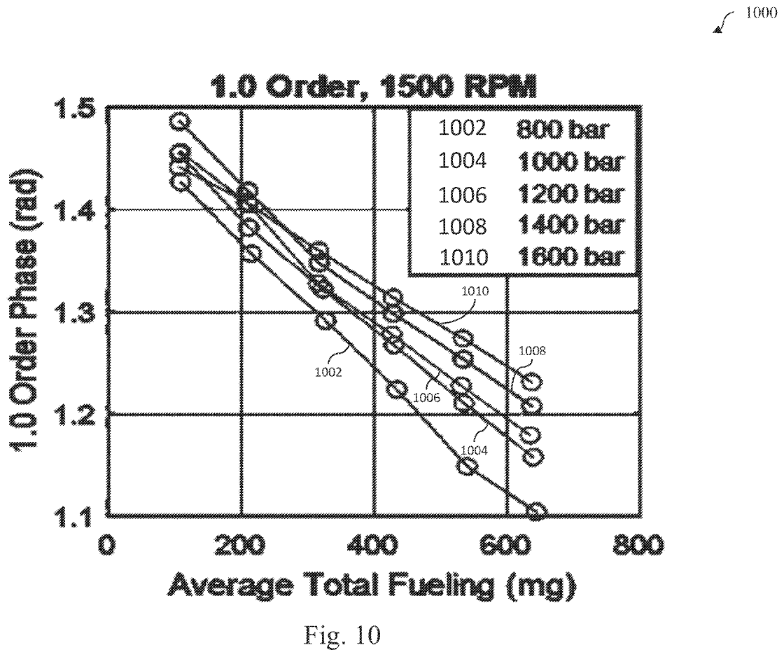

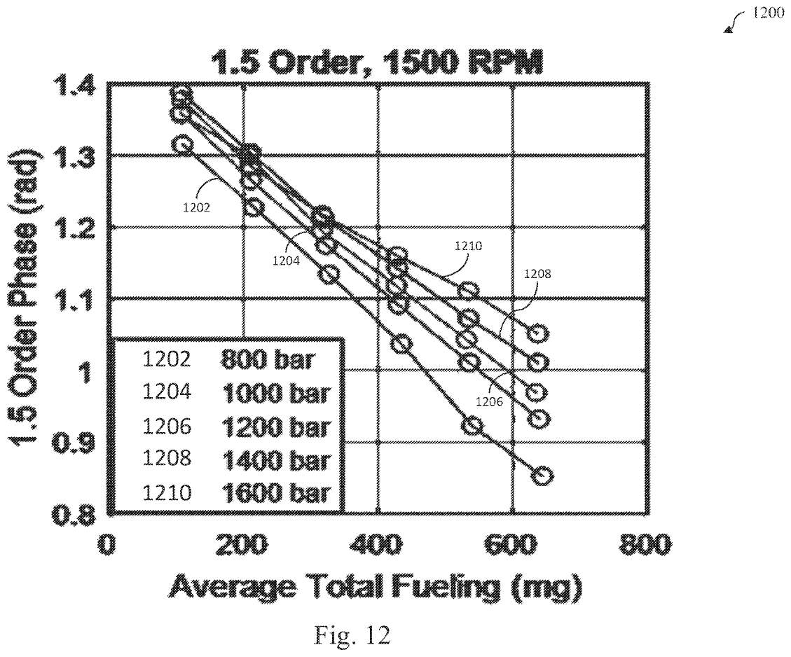

Average fueling parameter 418 is provided to and received as input to operator 428, operator 438, and operator 448 which are configured to determine a 0.5 order phase parameter (θ_{0.5}), a 1.0 order phase parameter (θ_{1.0}), and a 1.5 order phase parameter (θ_{1.5}), respectively, as a function of average fueling parameter 418. In some embodiment, the respective fueling imbalance parameters can be determined using look-up tables specifying values of θ_{0.5}, θ_{1.0}, and θ_{1.5} as a function of rail pressure firing frequency magnitude and average pressure (or square of sonic speed). FIG. 8 illustrates a graph 800 depicting curves 802, 804, 806, 808, 810 of 0.5 order phase as a function of average total fueling for a plurality of rail pressures. FIG. 10 illustrates a graph 1000 depicting curves 1002, 1004, 1006, 1008, 1010 of 1.0 order phase as a function of average total fueling for a plurality of rail pressures. FIG. 12 illustrates a graph 1200 depicting curves 1202, 1204, 1206, 1208, 1210 of 1.5 order phase as a function of average total fueling for a plurality of rail pressures.

The relationships illustrated in graphs 800, 1000, and 1200 may be implemented in and specified by one or more lookup tables. In other embodiments, the fueling imbalance parameters, can be determined by performing calculations using as set of linear or polynomial-fit equations generally corresponding to the relationships illustrated in FIG. 8, 10, or 12 generally corresponding to other empirically derived relationships.

Operator 450 receives as input the outputs of operator 426, operator 428, operator 436, operator 438, operator 446 and operator 448. Operator 450 is configured as operable to determine average delta fueling value for a given cylinder (ΔQ_{cyl}) 452 as equal to ΔQ_{firing order(i)} in accordance with equation (7), equation (8), equation (9), and equation (10):

$$Δ {Q}_{firing order ( i )} = {Q}_{0.5} * cos ( ( i - 1 ) \frac{π}{3} + {θ}_{0.5} ) + {Q}_{1.} * cos ( ( i - 1 ) \frac{2 π}{3} + {θ}_{1.} ) + {Q}_{1.5} * cos ( ( i - 1 ) π + {θ}_{1.5} ) \qquad ( 7 )$$

where Q_{0.5}, Q_{1.0}, Q_{1.5} are fueling imbalance magnitudes from operator 426, operator 436, and operator 446, respectively, firing order=[1 5 3 6 2 4], and i=1, . . . , 6).

$${θ}_{0.5} = {tan}^{- 1} ( \frac{{Im}_{0.5}}{{Re}_{0.5}} ) - {θ}_{{0}_{0.5}} \qquad ( 8 )$$

$${θ}_{1.} = {tan}^{- 1} ( \frac{{Im}_{0.5}}{{Re}_{0.5}} ) - {θ}_{{0}_{0.5}} \qquad ( 9 )$$

$${θ}_{1.5} = {tan}^{- 1} ( \frac{{Im}_{1.5} - {Mg}_{{1.5}_{nat}} * cos ( {θ}_{{1.5}_{nat}} )}{{Re}_{1.5} - {Mg}_{{1.5}_{nat}} * sin ( {θ}_{{1.5}_{nat}} )} ) - {θ}_{{0}_{1.5}} \qquad ( 10 )$$

Where: Q_{0.5}, Q_{1.0}, Q_{1.5} are phase references from operator 428, operator 438, and operator 448, respectively, (Re_{0.5}, Im_{0.5}), (Re_{1.0}, Im_{1.0}), (Re_{1.5}, Im_{1.5}) are the real & imaginary output by operator 420, operator 430, and operator 440, respectively, and Mg_{1.5}_{ₙₐₜ}, θ_{1.5}_{ₙₐₜ} are the magnitude and phase, respectively, of natural 1.5 order response from calibrated equation that is a linear function of overall average total fueling.

It shall be appreciated that the aforementioned “natural 1.5 order response” connotes that the rail pressure signal exhibits a small non-zero 1.5 order component even when the injectors are perfectly balanced due to the firing order and the location of the pressure sensor along the rail (which, in this example, is located close to one end of the rail). Although it may be possible to eliminate this by locating the pressure sensor in the middle of the rail, the effect may also be compensated by an equation or look-up table that is a function of overall average total fueling.

With reference to FIG. 4C, there are illustrated further aspects of controls 400. Operator 454 receives as input average fueling parameter 418 and average delta fueling value (ΔQ_{cyl}) 452. Operator 454 is configured and operable to determine an average fueling for a given cylinder (Q_{cyl}_{_{avg}}) 456 over a given sample period (four engine cycles in the present example) in accordance with equation (11):

$${Q}_{{cyl}_{avg}} = {Q}_{avg} + Δ {Q}_{cyl} \qquad ( 11 )$$

As illustrated and described in connection with FIGS. 4A, 4B, and 4C, controls 400 may be utilized to determine the average fueling for each injector over a four-cycle period. It shall be appreciated that under some operating conditions, commanded fueling may vary among cycles of that period. Accordingly, individual injection events may deviate from the average fueling values. As illustrated in FIG. 4D, an alternative implementation of controls 400 may be utilized to account and correct for variation in commanded fueling over the cycles of a given pressure sampling period.

As illustrated in FIG. 4D, operator 470 receives as input average fueling parameter (Q_{avg}) 418, an average commanded injection quantity over a sample period (Q_{cmd}_{ⱼ}) 460, average delta fueling value (Δ_{Q}_{_{cyl}}) 452, first commanded injection quantity (Q_{cmd}_{₁}) 461, second commanded injection quantity (Q_{cmd}_{₂}) 462, third commanded injection quantity (Q_{cmd}_{₃}) 463, and fourth commanded injection quantity (Q_{cmd}_{₄}) 464. Operator 470 is configured and operable to determine injection quantities for a particular engine cycle (Q_{cyl}_{ⱼ}) in accordance with equation 12 in which the “j” subscripts above pertain to the four injections that occur for each injector in a four engine cycle period:

$${Q}_{{cyl}_{j}} = {Q}_{{cmd}_{j}} - ( \frac{{Q}_{{cmd}_{1}} + {Q}_{{cmd}_{2}} + {Q}_{{cmd}_{3}} + {Q}_{{cmd}_{4}}}{4} ) + {Q}_{avg} + Δ {Q}_{cyl} \qquad ( 12 )$$

Operator 470 provides injection quantities for a particular engine cycle (Q_{cyl}_{ⱼ}) as output 472. Output 472 may, in turn, be utilized by any one or more of operation 482, 484, and 486, for example, as described above in connection with FIG. 4C.

While controls 400 is described in the context of fuel injection events by fuel injectors, it shall be appreciated that controls 400 may analogously be applied, mutatis mutandis, in the context of pumping events by a high pressure fuel pump. In such applications, aspects of controls 400 described above in relation to an injector or an injection generally correspond to a pump and a pumping event respectively.

It shall be appreciated that the frequencies needed to estimate pumped quantities typically depend on how the pump is geared to the crankshaft. The number of frequencies is also typically smaller because the pump may only have two or three cylinders. Additionally, in systems where the pump is usually controlled by modulating the continuous fuel flow through an inlet metering valve upstream of the pump, estimates of the average pumped quantity from each pump cylinder over the 4-cycle sampling window may be utilized in lieu of estimates of the quantity of each pump event since individual pump quantity commands are not available. Furthermore, the background leakage in the system can be estimated by subtracting the overall average injected quantity from the overall average pumped quantity and may be utilized for troubleshooting during service.

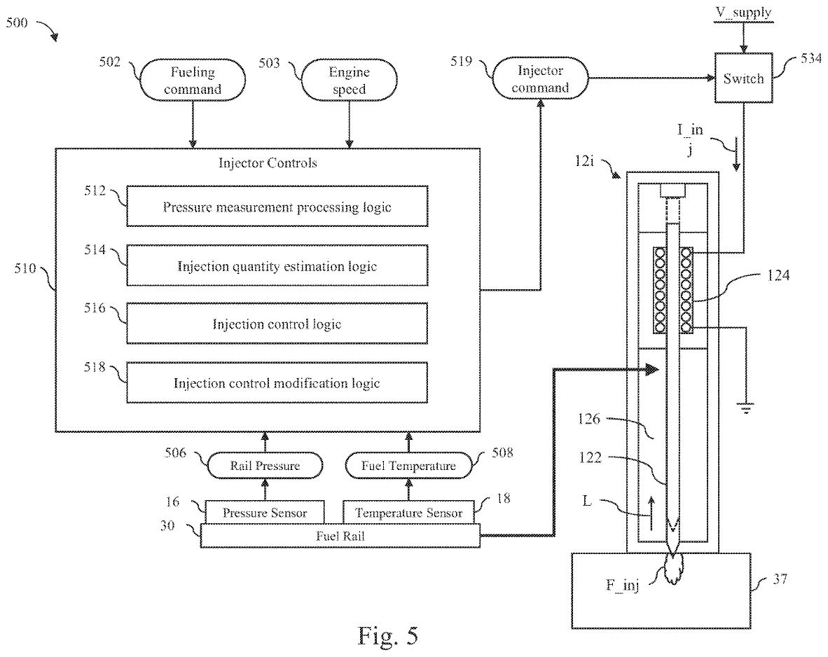

With reference to FIG. 5, there are illustrated example controls 500 which may be implemented in and operated by one or more components of an electronic control system such as ECS 20 or another electronic control system configured for operative communication with a fueling system. In some forms, at least a portion of controls 500 may be implemented in one or mode electronic control units of an electronic control system such as ECU 22 or additional or alternative electronic control units.

Controls 500 include injector controls 510 which are configured to determine and output at least one injector control signal 519 to control operation of an injector 12i in response to one or more inputs. In the illustrated example, injector controls 510 are configured to determine and output injector commands for a particular individual injector 12i. Controls 500 may include additional instances of injector controls the same as or similar to injector controls 510 which are configured to determine and output injector commands for other particular individual injectors.

In the illustrated example, injector controls 510 are configured to receive a plurality of inputs including fueling command 502, engine speed 503, rail pressure 506, and rail temperature 508. In other embodiments, injector controls 510 may be configured to receive additional or alternative inputs.

Fueling command 502 may include a fueling quantity (Q) and a fueling pressure (P). Fueling command 502 may be determined and provided to injector controls 510 in response to an operator input such as an accelerator pedal position or in response to automated operation of an electronic control system such as an adaptive cruise control system. Engine speed 503 may be provided by an engine speed sensor. Engine speed 503 may be provided to injector controls 510 via a dedicated connection or via one or more communication networks.

Rail pressure 506 may be provided by pressure sensor 16 which is in operative communication with and configured to sense a pressure of fuel rail 30 which is configured to supply fuel to injector 12i and may also be configured to supply fuel to other injectors. Rail pressure 506 may be provided to injector controls 510 via a dedicated connection or via one or more communication networks. Rail pressure 506 may be utilized as a rail pressure measurement utilized by the processes and controls disclosed herein and may be sampled repeatedly to determine multiple points or values of a rail pressure measurement.

Rail temperature 508 may be provided by temperature sensor 18 which is in operative communication with and configured to sense a temperature of fuel rail 30. Rail temperature 508 may be provided to injector controls 510 via a dedicated connection or via one or more communication networks. Rail temperature 508 may be utilized as a rail temperature utilized by the processes and controls disclosed herein and may be sampled repeatedly to determine multiple points or values of a rail temperature measurement.

Injector controls 510 comprise control circuitry configured to implement and execute control logic for processing the inputs received by injector controls 510 and to determine and output injector control signal 519. In the illustrated example the circuitry of injector controls 510 is configured to provide and execute pressure measurement processing logic 512, injection quantity estimation logic 514, injection control logic 516, and injection control modification logic 518. In other embodiments, the control logic provided by injector controls 510 may be differently organized with the aspects of one or more of the illustrated logic blocks being combined in a single block or units, divided into multiple blocks or units, and/or provided with additional or alternative blocks or units.

In the illustrated example, pressure measurement processing logic 512 and injection quantity estimation logic 514 are configured to implement and execute one or more operations of the processes and controls disclosed herein. Pressure measurement processing logic 512 is configured to perform a plurality of operations relating to the receipt and processing of a rail pressure 506. Injection quantity estimation logic 514 is configured to perform a plurality of operations relating to calculation of an injected fuel quantity estimate using the output of pressure measurement processing logic 512. In other embodiments, the foregoing operations may be differently distributed between or among pressure measurement processing logic 512, injection quantity estimation logic 514, and/or additional logic injector controls 510.

Injection control logic 516, is configured to determine injector commands to provide output including injector control signal 519. Injector control logic 516 may be configured to determine an injector on-time command effective to set injector control signal 519 to an injector-on state or value for a duration corresponding to a commanded injector on time. Injector control logic 516 may determine the injector on-time command in response to fueling command 502, and engine speed 503, rail pressure 506, and rail temperature 508 and may utilize a number of techniques to perform this determination.

In some embodiments, injector control logic 516 may be configured and provided as one or more lookup tables, maps or response surfaces which are configured and operable to provide an injector on-time command in response to the aforementioned inputs.

It shall be appreciated that additional tables for combinations of other fuel temperatures and engine speeds may also be provided in the set of tables 600. It shall also be appreciated that interpolation between a set of two or more tables, between a set of two or more curves of a given table may be utilized to determine intermediate values.

In some embodiments, injector control logic 516 may be configured and operable to solve one or more equations to determine an injector on-time command in response to the aforementioned inputs.

The injector-on state of injector control signal 519 may be effective to actuate switch 534. Switch 534 is operatively coupled with a system voltage source (V_supply) and configured to selectably supply an injector current (I_inj) a solenoid 124 of an injector 12. The injector current (I_inj) is effective to energize solenoid 124 to induce lifting motion of injector armature 122 (sometimes referred to as an injector needle) in the direction generally indicated by arrow L. In the lifted position (illustrated in phantom as denoted by dashed lines), injector armature 122 allows fuel supplied to injector gallery 126 to exit one or more apertures of a tip of injector 12 as an fuel injection (F_inj) into a port of intake manifold 37 leading to an associated combustion chamber of engine 10.

Injection control modification logic 518 is configured to modify a relationship between an injector on-time command and a commanded injection quantity which is utilized by injector control logic 516 as described above. In some embodiment injection control modification logic 518 may be configured to modify one or more tables defining one or more relationships between commanded on-time as a function of injection quantity at a given fuel pressure such as described above in connection with injector control logic 516. In some embodiment injection control modification logic 518 may be configured to modify one or more coefficients of an equation defining one or more relationships between commanded on-time as a function of injection quantity at a given fuel pressure. In some embodiments injection control modification logic 518 may be configured to modify one values in adaptive tables defining one or more relationships between commanded on-time as a function of injection quantity at a given fuel pressure such as described above in connection with injector control logic 516.

Injection control modification logic 518 may modify one or more of the foregoing relationships between an injector on-time command and a commanded injection quantity by comparing a calculated injected fuel quantity estimate, such as the estimate determined by process 300 and/or controls 400 described herein, with an existing model of the relationship. The existing model of the relationship may comprise a set of look-up tables.

Injection control modification logic 518 may compare a calculated injected fuel quantity estimate with a predicted injected quantity for an engine speed and fuel rail temperature, for example, by determining a difference between the calculated injected fuel quantity estimate and the predicted injected quantity.

As shown by this detailed description, the present disclosure contemplates multiple and various embodiments, including, without limitation, the following example embodiments.

A first example embodiment is a system comprising: an engine comprising a plurality of combustion cylinders; a fueling system comprising a fuel rail in fluid communication with a plurality of fuel injectors, each of the plurality of fuel injectors being configured to provide fuel to a respective one of the plurality of combustion cylinders, and a high-pressure fuel pump in fluid communication with the fuel rail; and an electronic control system in operative communication with the fueling system and configured to: receive pressure sensor output indicative of a fuel pressure of the fuel rail for a plurality of engine cycles, process the pressure sensor output to determine a fueling value indicative of a fuel quantity of an injection event of one of the plurality of fuel injectors, and in response to the fueling value, at least one of: adjust an injector control parameter to mitigate a difference between a commanded fueling quantity and an actual fueling quantity, display an operator perceptible output indicative of a condition of the system, and diagnose a condition of the system.

A second example embodiment includes the features of the first example embodiment, wherein the electronic control being configured to process the pressure sensor output to determine the fueling value indicative comprises the electronic control system being configured to: determine an average fueling value indicative of an average total fuel quantity of injections by the plurality of injectors, determine fueling imbalance parameters indicative of fueling quantity imbalance among the injections by the plurality of injectors, and determine the fueling value in response to the fueling value and the fueling imbalance parameters.

A third example embodiment includes the features of the second example embodiment, wherein the electronic control system being configured to determine the average fueling value comprises the electronic control system being configured to perform a Fourier transform at an integer multiple of an engine firing frequency.

A fourth example embodiment includes the features of the second example embodiment, wherein the electronic control system being configured to determine fueling imbalance parameters comprises the electronic control system being configured to perform a plurality of Fourier transforms at a plurality of engine orders lower than the engine order associated with firing frequency.

A fifth example embodiment includes the features of the second example embodiment, wherein the electronic control system being configured to determine the fueling value in response to the fueling value and the fueling imbalance parameters comprises the electronic control system being configured to adjust for inter-cycle variation of fueling by an injector in response to commanded fueling over a plurality of engine cycles.

A sixth example embodiment includes the features of the first example embodiment, wherein the electronic control system is configured to: process output of the pressure sensor to determine a fueling value indicative of a fuel quantity of a pumping event of a piston of the high-pressure fuel pump; determine a background leakage in the fueling system by subtracting an overall average injected quantity from an overall average pumped quantity; and provide the background leakage to troubleshoot the system during a service event.

A seventh example embodiment is a method of controlling an engine fueling system including a fuel rail in fluid communication with a plurality of fuel injectors, each of the plurality of fuel injectors configured to provide fuel to a respective one of a plurality of combustion cylinders, and a high-pressure fuel pump in fluid communication with the fuel rail, the method comprising: receiving pressure sensor output indicative of a fuel pressure of the fuel rail for a plurality of engine cycles, processing the pressure sensor output to determine a fueling value indicative of a fuel quantity of an injection event of one of the plurality of fuel injectors, and in response to the fueling value, at least one of: adjusting an injector control parameter to mitigate a difference between a commanded fueling quantity and an actual fueling quantity, displaying an operator perceptible output indicative of a condition of the system, and diagnosing a condition of the system.

An eighth example embodiment includes the features of the seventh example embodiment, wherein the processing the pressure sensor output comprises: determining an average fueling value indicative of an average total fuel quantity of injections by the plurality of injectors, determining fueling imbalance parameters indicative of fueling quantity imbalance among the injections by the plurality of injectors, and determining the fueling value in response to the fueling value and the fueling imbalance parameters.

A ninth example embodiment includes the features of the eighth example embodiment, wherein the determining the average fueling value comprises performing a Fourier transform at an integer multiple of an engine firing frequency.

A tenth example embodiment includes the features of the eighth example embodiment, wherein the determining fueling imbalance parameters comprises performing a plurality of Fourier transforms at a plurality of engine orders lower than the engine order associated with firing frequency.

An eleventh example embodiment includes the features of the eighth example embodiment, wherein determining the fueling value in response to the fueling value and the fueling imbalance parameters comprises adjusting for inter-cycle variation of fueling by an injector in response to commanded fueling over a plurality of engine cycles.

An twelfth example embodiment includes the features of the seventh example embodiment, comprising: processing output of the pressure sensor to determine a fueling value indicative of a fuel quantity of a pumping event of a piston of the high-pressure fuel pump; determining a background leakage in the fueling system by subtracting an overall average injected quantity from an overall average pumped quantity; and providing the background leakage to troubleshoot the system during a service event.

A thirteenth example embodiment is a system comprising: an engine comprising a plurality of combustion cylinders; a fueling system comprising a fuel rail in fluid communication with a plurality of fuel injectors, each of the plurality of fuel injectors being configured to provide fuel to a respective one of the plurality of combustion cylinders, and a high-pressure fuel pump in fluid communication with the fuel rail; and an electronic control system in operative communication with the fueling system and configured to: receive pressure sensor output indicative of a fuel pressure of the fuel rail for a plurality of engine cycles, process the pressure sensor output to determine a fueling value indicative of a fuel quantity of a pumping event of a piston of the high-pressure fuel pump, and in response to the fueling value, at least one of: adjust a pump control parameter to mitigate a difference between a commanded pumping quantity and an actual pumping quantity, display an operator perceptible output indicative of a condition of the system, and diagnose a condition of the system.

A fourteenth example embodiment includes the features of the thirteenth example embodiment, wherein the electronic control being configured to process the pressure sensor output to determine the fueling value indicative comprises the electronic control system being configured to: determine an average fueling value indicative of an average total fuel quantity of pumping events by a plurality of cylinders of the high-pressure fuel pump, determine fueling imbalance parameters indicative of pumping quantity imbalance among the pumping events by the plurality of cylinders, and determine the fueling value in response to the fueling value and the fueling imbalance parameters.

A fifteenth example embodiment includes the features of the fourteenth example embodiment, wherein the electronic control system being configured to determine the average fueling value comprises the electronic control system being configured to perform a Fourier transform at an integer multiple of a pumping event frequency.

A sixteenth example embodiment includes the features of the fourteenth example embodiment, wherein the electronic control system being configured to determine fueling imbalance parameters comprises the electronic control system being configured to perform a plurality of Fourier transforms at a plurality of engine orders lower than the engine order associated with a pumping event frequency.

A seventeenth example embodiment includes the features of the fourteenth example embodiment, wherein the electronic control system being configured to determine the fueling value in response to the fueling value and the fueling imbalance parameters comprises the electronic control system being configured to adjust for inter-cycle variation of fueling by the plurality of cylinders over a plurality of engine cycles.

An eighteenth fifteenth example embodiment includes the features of the thirteenth example embodiment, wherein the electronic controls system is configured to: process output of the pressure sensor to determine a fueling value indicative of a fuel quantity of an injection event of one of the plurality of fuel injectors; determine a background leakage in the fueling system by subtracting an overall average injected quantity from an overall average pumped quantity; and provide the background leakage to troubleshoot the system during a service event.

A nineteenth example is a method of controlling an engine fueling system including a fuel rail in fluid communication with a plurality of fuel injectors, each of the plurality of fuel injectors configured to provide fuel to a respective one of a plurality of combustion cylinders, and a high-pressure fuel pump in fluid communication with the fuel rail, the method comprising: receiving pressure sensor output indicative of a fuel pressure of the fuel rail for a plurality of engine cycles, processing the pressure sensor output to determine a fueling value indicative of a fuel quantity of a pumping event of one of a piston of the high-pressure fuel pump, and in response to the fueling value, at least one of: adjusting a pump control parameter to mitigate a difference between a commanded pumping quantity and an actual pumping quantity, displaying an operator perceptible output indicative of a condition of the system, and diagnosing a condition of the system.

A twentieth example embodiment includes the features of the nineteenth example embodiment, wherein the processing the pressure sensor output comprises: determining an average fueling value indicative of an average total fuel quantity of pumping events by a plurality of cylinders of the high-pressure fuel pump, determining fueling imbalance parameters indicative of pumping quantity imbalance among the pumping events by the plurality of cylinders, and determining the fueling value in response to the fueling value and the fueling imbalance parameters.

A twenty-first example embodiment includes the features of the twentieth example embodiment, wherein the determining the average fueling value comprises performing a Fourier transform at an integer multiple of a pumping event frequency.

A twenty-second example embodiment includes the features of the twentieth example embodiment, wherein the determining fueling imbalance parameters comprises performing a plurality of Fourier transforms at a plurality of engine orders lower than the engine order associated with a pumping event frequency.

A twenty-third example embodiment includes the features of the twentieth example embodiment, wherein determining the fueling value in response to the fueling value and the fueling imbalance parameters comprises adjusting for inter-cycle variation of fueling by the plurality of cylinders over a plurality of engine cycles.

A twenty-fourth example embodiment includes the features of the nineteenth example embodiment, comprising: processing output of the pressure sensor to determine a fueling value indicative of a fuel quantity of an injection event of one of the plurality of fuel injectors; determining a background leakage in the fueling system by subtracting an overall average injected quantity from an overall average pumped quantity; and providing the background leakage to troubleshoot the system during a service event.

It shall be appreciated that terms such as “a non-transitory memory,” “a non-transitory memory medium,” and “a non-transitory memory device” refer to a number of types of devices and storage mediums which may be configured to store information, such as data or instructions, readable or executable by a processor or other components of a computer system and that such terms include and encompass a single or unitary device or medium storing such information, multiple devices or media across or among which respective portions of such information are stored, and multiple devices or media across or among which multiple copies of such information are stored.

It shall be appreciated that terms such as “determine,” “determined,” “determining” and the like when utilized in connection with a control method or process, an electronic control system or controller, electronic controls, or components or operations of the foregoing refer inclusively to a number of acts, configurations, devices, operations, and techniques including, without limitation, calculation or computation of a parameter or value, obtaining a parameter or value from a lookup table or using a lookup operation, receiving parameters or values from a datalink or network communication, receiving an electronic signal (e.g., a voltage, frequency, current, or pulse-width modulation (PWM) signal) indicative of the parameter or value, receiving output of a sensor indicative of the parameter or value, receiving other outputs or inputs indicative of the parameter or value, reading the parameter or value from a memory location on a computer-readable medium, receiving the parameter or value as a run-time parameter, and/or by receiving a parameter or value by which the interpreted parameter can be calculated, and/or by referencing a default value that is interpreted to be the parameter value.

While example embodiments of the disclosure have been illustrated and described in detail in the drawings and foregoing description, the same is to be considered as illustrative and not restrictive in character, it being understood that only certain example embodiments have been shown and described and that all changes and modifications that come within the spirit of the claimed inventions are desired to be protected. It should be understood that while the use of words such as preferable, preferably, preferred or more preferred utilized in the description above indicates that the feature so described may be more desirable, it nonetheless may not be necessary and embodiments lacking the same may be contemplated as within the scope of the invention, the scope being defined by the claims that follow. In reading the claims, it is intended that when words such as “a,” “an,” “at least one,” or “at least one portion” are used there is no intention to limit the claim to only one item unless specifically stated to the contrary in the claim. When the language “at least a portion” and/or “a portion” is used the item can include a portion and/or the entire item unless specifically stated to the contrary.

1. A system comprising:
an engine comprising a plurality of combustion cylinders;
a fueling system comprising a fuel rail in fluid communication with a plurality of fuel injectors, each of the plurality of fuel injectors being configured to provide fuel to a respective one of the plurality of combustion cylinders, and a high-pressure fuel pump in fluid communication with the fuel rail; and
an electronic control system in operative communication with the fueling system and configured to:
receive pressure sensor output indicative of a fuel pressure of the fuel rail for a plurality of engine cycles,
process the pressure sensor output to determine a fueling value indicative of a fuel quantity of an injection event of one of the plurality of fuel injectors, and
in response to the fueling value, at least one of: adjust an injector control parameter to mitigate a difference between a commanded fueling quantity and an actual fueling quantity, display an operator perceptible output indicative of a condition of the system, and diagnose a condition of the system.

2. The system of claim 1, wherein the electronic control being configured to process the pressure sensor output to determine the fueling value indicative comprises the electronic control system being configured to:
determine an average fueling value indicative of an average total fuel quantity of injections by the plurality of injectors,
determine fueling imbalance parameters indicative of fueling quantity imbalance among the injections by the plurality of injectors, and
determine the fueling value in response to the fueling value and the fueling imbalance parameters.

3. The system of claim 2, wherein the electronic control system being configured to determine the average fueling value comprises the electronic control system being configured to perform a Fourier transform at an integer multiple of an engine firing frequency.

4. The system of claim 2, wherein the electronic control system being configured to determine fueling imbalance parameters comprises the electronic control system being configured to perform a plurality of Fourier transforms at a plurality of engine orders lower than the engine order associated with firing frequency.

5. The system of claim 2, wherein the electronic control system being configured to determine the fueling value in response to the fueling value and the fueling imbalance parameters comprises the electronic control system being configured to adjust for inter-cycle variation of fueling by an injector in response to commanded fueling over a plurality of engine cycles.

6. The system of claim 1, wherein the electronic control system is configured to:
process output of the pressure sensor to determine a fueling value indicative of a fuel quantity of a pumping event of a piston of the high-pressure fuel pump;
determine a background leakage in the fueling system by subtracting an overall average injected quantity from an overall average pumped quantity; and
provide the background leakage to troubleshoot the system during a service event.

7. A method of controlling an engine fueling system including a fuel rail in fluid communication with a plurality of fuel injectors, each of the plurality of fuel injectors configured to provide fuel to a respective one of a plurality of combustion cylinders, and a high-pressure fuel pump in fluid communication with the fuel rail, the method comprising:
receiving pressure sensor output indicative of a fuel pressure of the fuel rail for a plurality of engine cycles,
processing the pressure sensor output to determine a fueling value indicative of a fuel quantity of an injection event of one of the plurality of fuel injectors, and
in response to the fueling value, at least one of: adjusting an injector control parameter to mitigate a difference between a commanded fueling quantity and an actual fueling quantity, displaying an operator perceptible output indicative of a condition of the system, and diagnosing a condition of the system.

8. The method of claim 7, wherein the processing the pressure sensor output comprises:
determining an average fueling value indicative of an average total fuel quantity of injections by the plurality of injectors,
determining fueling imbalance parameters indicative of fueling quantity imbalance among the injections by the plurality of injectors, and
determining the fueling value in response to the fueling value and the fueling imbalance parameters.

9. The method of claim 8, wherein the determining the average fueling value comprises performing a Fourier transform at an integer multiple of an engine firing frequency.

10. The method of claim 8, wherein the determining fueling imbalance parameters comprises performing a plurality of Fourier transforms at a plurality of engine orders lower than the engine order associated with firing frequency.

11. The method of claim 8, wherein determining the fueling value in response to the fueling value and the fueling imbalance parameters comprises adjusting for inter-cycle variation of fueling by an injector in response to commanded fueling over a plurality of engine cycles.

12. The method of claim 7, comprising:
processing output of the pressure sensor to determine a fueling value indicative of a fuel quantity of a pumping event of a piston of the high-pressure fuel pump;
determining a background leakage in the fueling system by subtracting an overall average injected quantity from an overall average pumped quantity; and
providing the background leakage to troubleshoot the system during a service event.

13. A system comprising:
an engine comprising a plurality of combustion cylinders;
a fueling system comprising a fuel rail in fluid communication with a plurality of fuel injectors, each of the plurality of fuel injectors being configured to provide fuel to a respective one of the plurality of combustion cylinders, and a high-pressure fuel pump in fluid communication with the fuel rail; and
an electronic control system in operative communication with the fueling system and configured to:
receive pressure sensor output indicative of a fuel pressure of the fuel rail for a plurality of engine cycles,
process the pressure sensor output to determine a fueling value indicative of a fuel quantity of a pumping event of a piston of the high-pressure fuel pump, and
in response to the fueling value, at least one of: adjust a pump control parameter to mitigate a difference between a commanded pumping quantity and an actual pumping quantity, display an operator perceptible output indicative of a condition of the system, and diagnose a condition of the system.

14. The system of claim 13, wherein the electronic control being configured to process the pressure sensor output to determine the fueling value indicative comprises the electronic control system being configured to:
determine an average fueling value indicative of an average total fuel quantity of pumping events by a plurality of cylinders of the high-pressure fuel pump,
determine fueling imbalance parameters indicative of pumping quantity imbalance among the pumping events by the plurality of cylinders, and
determine the fueling value in response to the fueling value and the fueling imbalance parameters.

15. The system of claim 14, wherein the electronic control system being configured to determine the average fueling value comprises the electronic control system being configured to perform a Fourier transform at an integer multiple of a pumping event frequency.

16. The system of claim 14, wherein the electronic control system being configured to determine fueling imbalance parameters comprises the electronic control system being configured to perform a plurality of Fourier transforms at a plurality of engine orders lower than the engine order associated with a pumping event frequency.

17. The system of claim 14, wherein the electronic control system being configured to determine the fueling value in response to the fueling value and the fueling imbalance parameters comprises the electronic control system being configured to adjust for inter-cycle variation of fueling by the plurality of cylinders over a plurality of engine cycles.

18. The system of claim 13, wherein the electronic controls system is configured to:
process output of the pressure sensor to determine a fueling value indicative of a fuel quantity of an injection event of one of the plurality of fuel injectors;
determine a background leakage in the fueling system by subtracting an overall average injected quantity from an overall average pumped quantity; and
provide the background leakage to troubleshoot the system during a service event.

19.-24. (canceled)
